(19) United States
(12) Patent Application Publication
(10) Pub. No.: US 2018/0204571 A1
(43) Pub. Date: Jul. 19, 2018

(54) DIALOG DEVICE AND DIALOG CONTROL METHOD

(71) Applicant: DENSO CORPORATION, Kariya-city, Aichi-pref. (JP)

(72) Inventors: Toru NADA, Kariya-city (JP); Makoto MANABE, Kariya-city (JP); Takuya IWASA, Kariya-city (JP)

(21) Appl. No.: 15/744,150

(22) PCT Filed: Sep. 23, 2016
(86) PCT No.: PCT/JP2016/077974

§ 371 Date: Jan. 12, 2018

(30) Foreign Application Priority Data
Sep. 28, 2015 (JP) 2015-189976

(51) Int. Cl. G10L 15/22; G10L 13/02

(52) U.S. Cl. CPC G10L 15/22; G10L 13/02

(57) ABSTRACT

A dialog device capable of achieving a conversation satisfactory to a user is provided. The dialog device includes: a conversation execution unit that executes a conversation with a user; a continuation determination unit that determines whether the conversation executed by the conversation execution unit and directed to the user continues; and an utterance control unit that controls the conversation execution unit to be in a standby state in which utterance to the user is suspended when the continuation determination unit determines that the conversation continues and no utterance shows that the user expresses an interest in an information presentation provided by the conversation execution unit.

### CROSS REFERENCE TO RELATED APPLICATION

This application is based on Japanese Patent Application No. 2015-189976 filed on Sep. 28, 2015, the disclosure of which is incorporated herein by reference.

### TECHNICAL FIELD

The present disclosure relates to a dialog device for having a conversation with a user, and a dialog control method.

### BACKGROUND ART

As a kind of dialog device for having a conversation with a user, for example, Patent Literature 1 discloses a simulated conversation system that recognizes words inputted by the user and ends a conversation. Specifically, in the simulated conversation system of Patent Literature 1, when the user's reaction to a question made from the system gives an unfavorable impression, e.g., being rough or arrogant, the mode is shifted to a final mode to end the conversation.

### PRIOR ART LITERATURES

### Patent Literature

Patent Literature 1: JP-2002-169590-A

### SUMMARY OF INVENTION

In the simulated conversation system of Patent Literature 1, when the user's reaction to the question gives an unfavorable impression, the conversation is one-sidedly terminated under the system's initiative. Hence, it can be thought that the user has entered the state of feeling ill of the system when the conversation is ended. Further, the conversation ending mode is also system-initiated, and the system one-sidedly informs the user that the conversation will be ended. Accordingly, the user remains unsatisfied with the conversation with the system. However, when the conversation is forced to be continued while the user's unfavorable impression is ignored in order to satisfy the user, the user all the more increases the dissatisfaction.

In view of such circumstances, it is an object of the present disclosure to provide a dialog device and a dialog control method capable of achieving a conversation satisfactory to a user.

According to an aspect of the present disclosure, a dialog device includes: a conversation execution unit that executes a conversation with a user; a continuation determination unit that determines whether the conversation executed by the conversation execution unit and directed to the user continues; and an utterance control unit that controls the conversation execution unit to be in a standby state in which utterance to the user is suspended when the continuation determination unit determines that the conversation continues and no utterance (e.g., utterance of information from the user, utterance of a question, a gesture such as back-channeling and nodding, the tone of voice, etc) shows that the user expresses an interest in an information presentation provided by the conversation execution unit.

With this configuration, it is after the conversation between the user and the dialog device continues that the state shifts to the standby state in which the utterance to the user is suspended. Hence, a situation hardly occurs in which the conversation is terminated by the dialog device without the user being satisfied with the conversation with the dialog device. Meanwhile, when the conversation between the user and the dialog device has continued, the conversation execution unit is held in the standby state unless there is utterance to allow grasping that the user has shown an interest. Hence, a situation hardly occurs in which the conversation is continued while ignoring the user's wish to end the conversation, thereby making the user feel dissatisfied. As above, according to the control of shifting the state to the standby state based on the user's reaction after continuation of the conversation, the dialog device can achieve a conversation satisfactory to the user.

According to an aspect of the present disclosure, a dialog control method for controlling a conversation execution unit that executes a conversation with a user, the dialog control method includes: as steps to be executed by at least one processor, a continuation determination step of determining whether a conversation executed by the conversation execution unit and directed to the user continues; and an utterance control step of controlling the conversation execution unit to be in a standby state in which utterance to the user is suspended when it is determined that the conversation continues in the continuation determination step and no utterance shows that the user expresses an interest in information presentation provided by the conversation execution unit.

Further, as a dialog control method of another aspect of the present disclosure is a dialog control method that controls a conversation execution unit that has a conversation with a user; the dialog control method comprising, as steps to be performed by at least one control server present in another place such as the Internet and connected from the dialog device via the communication processing unit: a continuation determination step of determining whether a conversation made by the conversation execution unit and directed to the user has continued; and an utterance control step of bringing the conversation execution unit into a standby state in which utterance to the user is suspended when it is determined in the continuation determination step that the conversation is continued and there is no utterance to allow grasping that the user has shown an interest in information presentation by the conversation execution unit. In this case, a conversation speech of the user fetched by the dialog device may go through conversion to a generally known digital-processed form, a form of an information amount compressed by a feature amount calculation, or some other form, and may be transmitted to a speech recognition unit in a control server via the communication processing unit. Similarly, speech data for conversation, created in a conversation processing unit on the control server side, and character data for image information display may also be transmitted to the dialog device in the digitalized or compressed form, and outputted to the user.

Also in the above dialog control method, the state can be shifted to the standby state based on the user's reaction after continuation of the conversation with the user, thereby enabling achievement of a conversation satisfactory to the user.

Moreover, according to another aspect of the present disclosure, there is provided a program for causing at least one processor to execute the above dialog control method. This program also exerts the above-described effect. Note that the program may be provided via an electrical communication line, or may be provided as stored in a non-transitory storage medium.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram showing an overall configuration of a dialog device according to an embodiment.

FIG. 2 is a diagram schematically showing the Yerkes-Dodson Law that explains a correlation between an arousal and driving performance of a driver.

FIG. 3 is a diagram explaining functional blocks and sub blocks constructed in a control circuit.

FIG. 4 is a flowchart showing conversation start processing performed in a control circuit.

FIG. 5 is a first flowchart showing conversation execution processing performed in the control circuit.

FIG. 6 is a second flowchart showing the conversation execution processing performed in the control circuit.

FIG. 7 is a block diagram showing an overall configuration of a dialog system according to a modified example.

### EMBODIMENTS FOR CARRYING OUT INVENTION

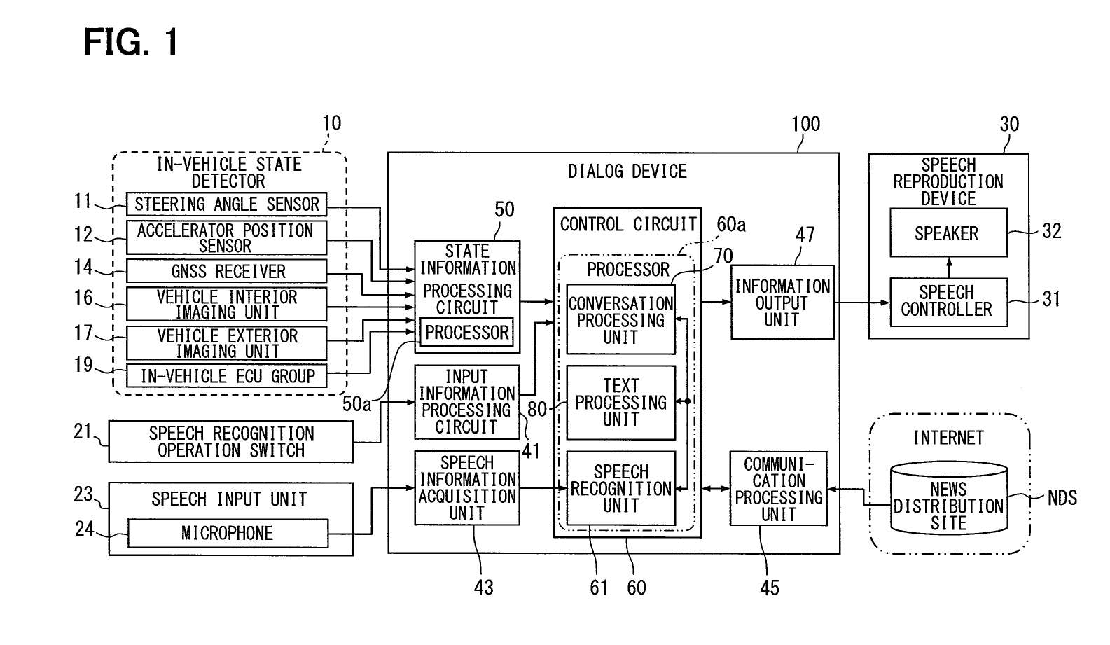

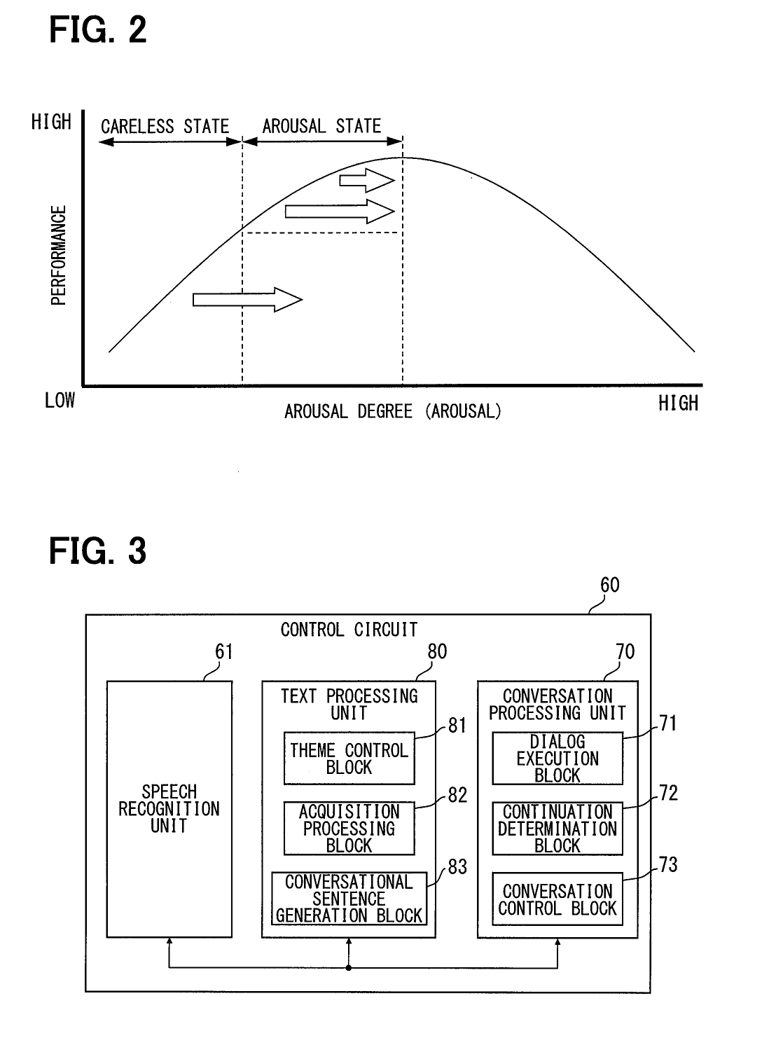

A dialog device 100 according to one embodiment shown in FIG. 1 is mounted in a vehicle and capable of having a conversation with a passenger of the vehicle, which is a user. The dialog device 100 is actively capable of dialoguing mainly with a driver among passengers of the vehicle. As shown in FIG. 2, the dialog device 100 has a conversation with the driver so as to hold the driver in a normal arousal state where the driver can show high driving performance. Further, the dialog device 100 can play a role of bringing the arousal of the driver who having entered a careless state and the driver beginning to enter a drowsy state back into the normal arousal state, by the conversation with the driver.

As shown in FIG. 1, the dialog device 100 is electrically connected with an in-vehicle state detector 10, a speech recognition operation switch 21, a speech input unit 23, and a speech reproduction device 30. Moreover, the dialog device 100 is connected to the Internet, and can acquire information from the outside of the vehicle through the Internet.

The in-vehicle state detector 10 is a variety of sensors and electronic equipment mounted in the vehicle. The in-vehicle state detector 10 includes at least a steering angle sensor 11, an accelerator position sensor 12, a GNSS (Global Navigation Satellite System) receptor 14, a vehicle interior imaging unit 16, a vehicle exterior imaging unit 17, and an in-vehicle ECU (Electronic Control Unit) group 19.

The steering angle sensor 11 detects a steering angle of a steering wheel steered by the driver and outputs a detection result to the dialog device 100. The accelerator position sensor 12 detects an amount of pressing an accelerator pedal by the driver and outputs a detection result to the dialog device 100.

The GNSS receptor 14 receives a positioning signal transmitted from a plurality of positioning satellites to acquire position information showing the current position of the vehicle. The GNSS receptor 14 outputs the acquired position information to the dialog device 100, a navigation ECU (described later), and the like.

The vehicle interior imaging unit 16 includes, for example, a near-infrared camera combined with a near-infrared light source. The near-infrared camera is installed in the vehicle interior and mainly shoots the driver's face by light applied from the near-infrared light source. By performing image analysis, the vehicle interior imaging unit 16 extracts from the shot image a direction of a visual line of the driver's eyes, opening conditions of the eyes (eyelids), and the like. The vehicle interior imaging unit 16 outputs information of the extracted direction of the driver's visual line, the extracted opening conditions of the eyes, and the like to the dialog device 100.

By including a plurality of near-infrared cameras and visible light cameras, and the like, the vehicle interior imaging unit 16 can shoot, for example, a range other than the driver's face and detect movement of the driver's hands and body. With such a configuration, the vehicle interior imaging unit 16 recognizes a predetermined gesture made by the driver and outputs, to the dialog device 100, information indicating that the gesture has been inputted.

The vehicle exterior imaging unit 17 is a visible light camera installed inside or outside the vehicle in a posture facing the surroundings of the vehicle, for example. The vehicle exterior imaging unit 17 shoots the surroundings of the vehicle which include at least the front of the vehicle. By performing image analysis, the vehicle exterior imaging unit 17 extracts a road shape in the traveling direction, road congestion conditions around the vehicle, and some other information from the shot images. The vehicle exterior imaging unit 17 outputs information showing the road shape, the congestion conditions, and the like to the dialog device 100. The vehicle exterior imaging unit 17 may include a plurality of visible light cameras, near-infrared cameras, distance image cameras, and the like.

The in-vehicle ECU group 19 includes ECUs each mainly made up of a microcomputer, and includes an integrated control ECU, a mechanism control ECU, a navigation ECU, and the like. From the navigation ECU, for example, information showing a road shape around the vehicle, or some other information, is outputted.

The speech recognition operation switch 21 is provided around the driver's seat. The speech recognition operation switch 21 receives an operation with respect to a conversation function of the dialog device 100 from the passenger of the vehicle. The operation includes an operation for switching activation between on and off, and an operation for canceling the standby state. The speech recognition operation switch 21 outputs operation information, inputted by the passenger, to the dialog device 100. An operation of changing a set value concerning the conversation function of the dialog device 100 may be made inputtable into the speech recognition operation switch 21.

The speech input unit 23 includes a microphone 24 provided in the vehicle interior. The microphone 24 converts speech of a conversation uttered by the passenger of the vehicle into an electrical signal and outputs the converted signal as speech information to the dialog device 100. The microphone 24 may be configured for a phone call, being provided in communication equipment such as a smartphone or a tablet terminal. Further, speech data collected by the microphone 24 may be wirelessly transmitted to the dialog device 100.

The speech reproduction device 30 is a device having an output interface function of outputting information to the passenger. The speech reproduction device 30 includes a display unit, a speech controller 31, and a speaker 32. When the speech controller 31 acquires speech data of conversational sentences, the speech controller drives the speaker 32 on the basis of the acquired speech data. The speaker 32 is provided in the vehicle interior, and outputs speech in the vehicle interior. The speaker 32 reproduces conversational sentences such that the passengers including the driver in the vehicle can listen to the sentences.

The speech reproduction device 30 may be simple acoustic equipment, or may be a communication robot installed on the upper surface of an instrument panel, or the like. The communication equipment such as the smartphone or the tablet terminal connected to the dialog device 100 may serve as the speech reproduction device 30.

Next, the configuration of the dialog device 100 will be described. The dialog device 100 is made up of an input information acquisition unit 41, a speech information acquisition unit 43, a communication processing unit 45, an information output unit 47, a state information processing circuit 50, a control circuit 60, and the like.

The input information acquisition unit 41 is connected with the speech recognition operation switch 21. The input information acquisition unit 41 acquires operation information outputted from the speech recognition operation switch 21 and provides the acquired operation information to the control circuit 60. The speech information acquisition unit 43 is an interface for inputting speech, connected with the microphone 24. The speech information acquisition unit 43 acquires speech information outputted from the microphone 24 and provides the acquired speech information to the control circuit 60.

The communication processing unit 45 includes an antenna for mobile communication. The communication processing unit 45 transmits and receives information to and from a base station outside the vehicle via the antenna. The communication processing unit 45 is connectable to the Internet through the base station. The communication processing unit 45 can acquire a variety of pieces of content information through the Internet. Examples of the pieces of content information include news article information, column article information, blog article information, traffic information such as traffic jam information showing congestion conditions around the current position where the vehicle is traveling, and regional information such as popular spots, events, and a weather forecast around the current point. The content information is acquired from at least one or more news distribution sites NDS on the Internet, for example.

The information output unit 47 is an interface that is connected with the speech reproduction device 30 and that outputs speech. The information output unit 47 outputs speech data, generated by the control circuit 60, to the speech reproduction device 30. The speech data outputted from the information output unit 47 is acquired by the speech controller 31 and reproduced by the speaker 32.

The state information processing circuit 50 acquires information outputted from the in-vehicle state detector 10 to mainly estimate the driver's state. The state information processing circuit 50 is mainly made up of a microcomputer including a processor 50a, a RAM, and a flash memory. The state information processing circuit 50 is provided with a plurality of input interfaces that receive signals from the in-vehicle state detector 10. The state information processing circuit 50 can achieve a burden determination function and an arousal state determination function, by the processor 50a executing a predetermined program.

The burden determination function is a function that determines whether the driving burden on the driver is high on the road where the vehicle is currently driving. The state information processing circuit 50 acquires detection results outputted from the steering angle sensor 11 and the accelerator position sensor 12 When the state information processing circuit 50 estimates that the driver is busily operating at least one of the steering and the accelerator pedal based on transition of the acquired detection results, the burden determination block 51 determines that the current driving burden is high. Further, when the state information processing circuit 50 estimates from an image shot by the vehicle interior imaging unit 16 that the driver is making a big movement, and when the vehicle's speed is high, the state information processing circuit 50 determines that the current driving burden is high.

Further, the state information processing circuit 50 acquires shape information of the road where the vehicle is traveling, traffic information showing congestion conditions around the vehicle, and some other information. The shape information of the road can be acquired from the vehicle exterior imaging unit 17 and the navigation ECU. The traffic information can be acquired from the vehicle exterior imaging unit 17 and the communication processing unit 45. When the road in the traveling direction has a curved shape and when the vehicle is estimated to be traveling in a traffic jam, the state information processing circuit 50 determines that the current driving burden is high.

On the other hand, when the vehicle is traveling on mostly a linear road and few other traveling vehicles and pedestrians are around the vehicle, the state information processing circuit 50 determines that the current driving burden is low. Also when the operating amounts of the steering and the accelerator pedal fluctuate slightly, the state information processing circuit 50 can determine that the driving burden is low.

The arousal state determination function determines whether the driver is in the careless state or the drowsy state. When the state information processing circuit 50 detects a careless operation on the steering or the accelerator pedal, an occasionally inputted large correction operation, or the like based on transition of the detection results acquired from each of the sensors 11, 12, the arousal state determination function determines that the driver is in the careless state or the drowsy state.

Further, the state information processing circuit 50 acquires, from the vehicle interior imaging unit 16, information such as a direction of a visual line of the driver's eyes and opening conditions of the eyes. When the parallax of the eyes is unstable or is not in an appropriate state for perception of an object in the traveling direction, and when the opening degree of the eyes continues to be low, the arousal state determination function determines that the driver is in the careless state or the drowsy state.

The control circuit 60 is a circuit that integrally controls a conversation exchanged with the user. The control circuit 60 is mainly made up of a microcomputer including a processor 60a, a RAM, and a flash memory. The control circuit 60 is provided with an input/output interface connected with other configurations of the dialog device 100.

The control circuit 60 executes a predetermined dialog control program by the processor 60a. As a result, the control circuit 60 constructs, as functional blocks, a speech recognizer 61, a text processing unit 80, and a conversation processing unit 70. Hereinafter, a detail of each functional block constructed in the control circuit 60 will be described based on FIGS. 1 and 3.

The speech recognizer 61 acquires a content of the user's utterance. The speech recognizer 61 is connected with the speech information acquisition unit 43 and acquires speech data from the speech information acquisition unit 43. The speech recognizer 61 reads the acquired speech data and converts the read data to text data. The speech recognizer 61 converts, into text data, words uttered by the passengers including the driver in the vehicle interior, such as the user's question thrown at the dialog device 100, the user's monologue, and a conversation between the users. The speech recognizer 61 then provides the text data to the text processing unit 80.

The text processing unit 80 acquires content information through the communication processing unit 45 and generates a conversational sentence for use in a conversation with the user by using the acquired content information.

The text processing unit 80 can acquire from the speech recognizer 61 a content of the user's utterance converted into the text data, to generate a conversational sentence of content corresponding to the utterance of the user. The text processing unit 80 includes, as sub blocks, a theme control block 81, an information acquisition block 82, and a conversational sentence generation block 83.

The theme control block 81 identifies the content of the user's utterance based on the text data acquired from the speech recognizer 61. The theme control block 81 controls the topic of the conversation directed to the user in accordance with the content of the user's utterance. Specifically, the theme control block 81 determines whether the user's utterance, made in response to information presentation from the dialog device 100, is utterance including information and a question that the user is interested in or substantially uninformative utterance. The substantially uninformative utterance is a vague answer such as “Oh, yeah?”, “I see”, or “Is that so?”

The theme control block 81 determines whether the information presentation by the dialog device 100 has a content capable of completing the topic having been used in a series of conversations. An utterance control block 73 determines whether the user's utterance, made in response to such information presentation that completes the topic (hereinafter referred to as completing information presentation) is utterance including information and a question that the user is interested in, or substantially uninformative utterance.

The theme control block 81 determines, from the user's reaction to the information presentation from the dialog device 100, whether the topic needs to be changed. The theme control block 81 determines that the topic needs to be changed when the user gives unfavorable impression, such as the user making substantially uninformative utterance, or no user's utterance having been recognized. Further, also when the utterance including information and a question that the user is interested in is made, the theme control block 81 determines whether to change the topic based on the content of the utterance. For example, when the user utters a word associated with the current topic, the theme control block 81 changes the topic. Also when the topic needs to be changed in order to answer the user's question, the theme control block 81 changes the topic.

The information acquisition block 82 acquires content information to be used for a conversational sentence through the communication processing unit 45. The information acquisition block 82 can search content information from the Internet in accordance with a condition set by the theme control block 81. When the topic is changed for improving the user's favorable impression, the information acquisition block 82 tries to acquire content information linked to the current topic in terms of the content. By such processing, the relevance occurs between conversational sentences before and after the change in the theme of the conversation, to achieve natural shift of the topic. Meanwhile, when the topic is to be changed for responding to the user, the information acquisition block 82 tries to acquire content information including information necessary for responding to the user. For example, when a new word is uttered by the user, the information acquisition block 82 searches content information including this word.

The conversational sentence generation block 83 generates a conversational sentence to be uttered to the user by using the content information or the like acquired by the information acquisition block 82. The content of the conversational sentence generated by the conversational sentence generation block 83 is controlled by the theme control block 81 so as to be a response content suitable for the user's utterance made immediately before. The conversational sentence generation block 83 provides generated conversational sentence text data to the conversation processing unit 70.

The conversation processing unit 70 has a conversation with the user by using the conversational sentence generated by the text processing unit 80. The conversation processing unit 70 includes a dialog execution block 71, a continuation determination block 72, and an utterance control block 73 as sub blocks for controlling the conversation with the user.

The dialog execution block 71 acquires the text data of conversational sentences generated by the conversational sentence generation block 83 to synthesize speech data of the acquired conversational sentence. The dialog execution block 71 may perform syllable connection-type speech synthesis, or may perform corpus base-type speech synthesis. Specifically, the dialog execution block 71 generates rhythm data at the time of utterance from the conversational sentence text data. The dialog execution block 71 then joins pieces of speech waveform data from previously stored speech waveform database in accordance with the rhythm data. From the above process, the dialog execution block 71 can convert the conversational sentence text data to the speech data.

The dialog execution block 71 outputs the conversational sentence speech data from the information output unit 47 to the speech controller 31, and causes the speaker 32 to utter the conversational sentence, to execute the conversation directed to the user. The utterance control block 73 controls the timing at which the dialog execution block 71 starts the conversation.

The continuation determination block 72 determines whether the conversation directed to the user by the dialog device 100 has continued based on whether the following two criterions of determination are both satisfied. The first criterion of determination is whether the elapsed time from start of the conversation directed to the user has exceeded a threshold. An elapsed time to be the threshold is set to the time for which the conversation is expected to exert a refreshing effect on the driver, and is about three to five minutes, for example. The threshold of the elapsed time may be a fixed value, or may be set at random between about three to five minutes or within a predetermined time range. The second criterion of determination is whether the number of conversations repeated between the user and the dialog device 100 regarding one topic has exceeded a threshold (e.g., about three to five times).

The continuation determination block 72 measures the elapsed time from the point of starting the conversation. The continuation determination block 72 counts the number of utterance of conversational sentences, based on one topic, namely one piece of content information. When the elapsed time from the conversation start exceeds the threshold and the number of repeated conversations also exceeds the threshold, the continuation determination block 72 makes a positive determination that the conversation with the user has continued.

The utterance control block 73 controls the execution of the conversation by the dialog execution block 71. For example, when an instruction to bring the conversation function of the dialog device 100 into an off-state has been inputted by operation on the speech recognition operation switch 21, the utterance control block 73 stops the activation of the dialog execution block 71.

The utterance control block 73 switches the activation status of the dialog execution block 71 between a forbidden state and a permitted state, in accordance with the burden determination made by the state information processing circuit 50. Specifically, when the burden determination function determines that the driving burden is high, the dialog execution block 71 sets the activation status of the dialog execution block 71 in the forbidden state in which the start of utterance is forbidden. On the other hand, when the burden determination function determines that the driving burden is low, the utterance control block 73 sets the activation status of the dialog execution block 71 to the permitted state in which the utterance start is permitted.

Further, the utterance control block 73 can shift the activation status of the dialog execution block 71 from the permitted state to the standby state. The utterance control block 73 sets the dialog execution block 71 to the standby state when the continuation determination block 72 makes a positive determination on the conversation continuation and the theme control block 81 determines that there is no utterance to allow grasping that the user has shown an interest in the completing information presentation.

In the standby state, the utterance start is controlled as in the forbidden state, and the utterance by the dialog execution block 71 enters the suspended state. However, while the forbidden state cannot practically be canceled by the user's intention, the standby state can be canceled by the user's intention by the user's utterance, gesture, input into the speech recognition operation switch 21, and the like.

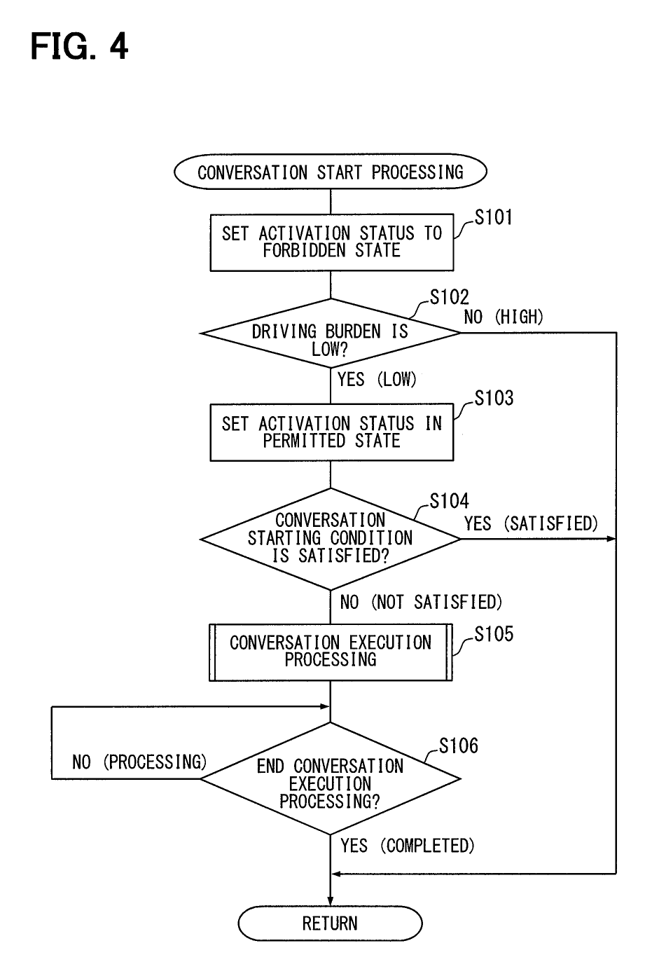

A further description will be given of a detail of the conversation start processing and the conversation execution processing which are performed by the control circuit 60 as above. First, a detail of the conversation start processing will be described based on FIG. 4 with reference to FIG. 3. Each step of the conversation start processing shown in FIG. 4 is carried out mainly by the conversation processing unit 70. The conversation start processing is started based on that the power of the vehicle is brought into the on-state, and is repeatedly started until the power of the vehicle is brought into the off-state.

In S101, as an initial setting, the activation status of the dialog execution block 71 is set in the forbidden state, and the processing proceeds to S102. In S102, a determination result of burden determination made by the state information processing circuit 50 (FIG. 1) is acquired, to determine whether the current driving burden on the user is low. When it is determined that the current driving burden is high in S102, the processing proceeds to S106.

On the other hand, when it is determined that the driving burden is low in S102, the processing proceeds to S103.

In S103, the activation status of the dialog execution block 71 is switched from the forbidden state to the permitted state, and the processing proceeds to S104. In S104, it is determined whether a conversation starting condition has been satisfied. Examples of the conversation starting condition include a condition as to whether the user is in the careless state or the drowsy state, and a condition as to whether there is such latest content information as to belong to the driver's preference category. When it is determined that the conversation starting condition has not been satisfied in S105, the conversation start processing is once ended. On the other hand, when it is determined that the conversation starting condition has been satisfied in S104, the processing proceeds to S105.

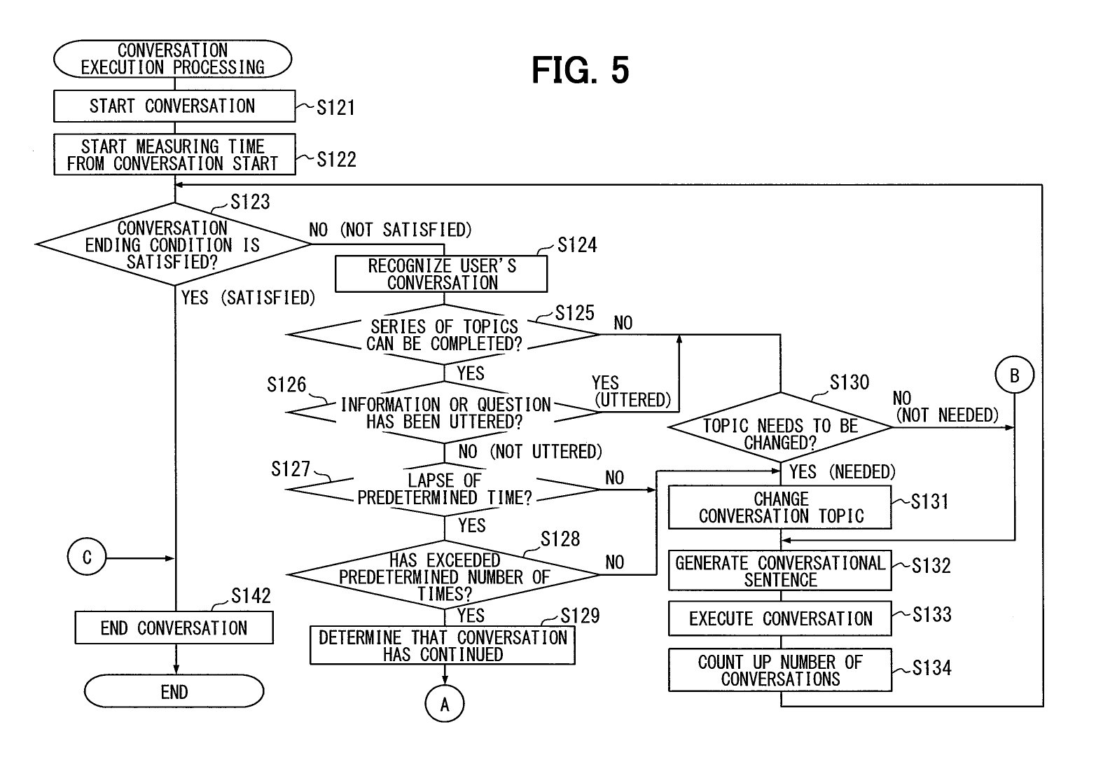

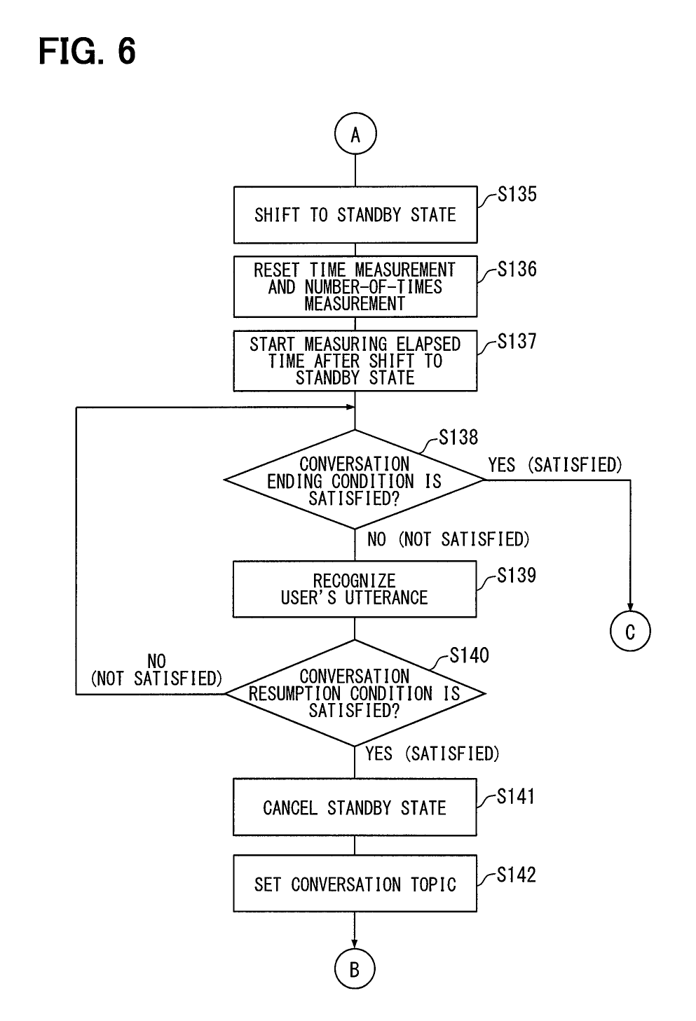

In S105, the conversation execution processing (cf. FIGS. 5 and 6) as the sub routine of the conversation start processing is started, and the processing proceeds to S106. In S106, it is determined whether the conversation execution processing is being performed. When it is determined that the conversation execution processing still continues in S106, the standby is kept until the conversation execution processing ends by repeating the determination of S106. When it is determined that the conversation execution processing has been completed, the conversation start processing is once ended.

Next, a detail of the conversation execution processing started in S105 will be described based on FIGS. 5 and 6 with reference to FIG. 3. Steps of the conversation execution processing are respectively performed by sub blocks of the conversation processing unit 70 and the text processing unit 80.

In S121, a conversation with the user is started, and the processing proceeds to S122. From S121, speaking to the user is started with a conversational sentence like “Do you know . . . ?” The conversation directed to the user is achieved by cooperation between the conversational sentence generation block 83 for generating a conversational sentence and the dialog execution block 71 for converting the generated conversational sentence into speech data. In S122, measurement of the time from the conversation start is started, and the processing proceeds to S123.

In S123, it is determined whether a conversation ending condition has been satisfied. Examples of the conversation ending condition include a condition that the driver has entered the arousal state by the conversation, a condition that the user has uttered instructing to end the conversation, and a condition that the driving burden on the user has increased.

As for grasping of the user's arousal state, the following methods can be used as known techniques: a method of processing a camera image of the user's face or body shot by the vehicle interior imaging unit (16), to grasp a drowsiness degree and a body movement situation; a method of detecting a state change as a result of operation of the switch provided in the in-vehicle ECU group (19); a method of determining a changing degree from operating situations of the steering angle sensor (11) and the accelerator position sensor (12); and some other method.

As for the utterance from the user to instruct to end the conversation, there is known a method of detecting a word or wording which means ending by using a known speech recognition system.

As a method for detecting an increase in driving burden, the following methods can be used: a method of determining a changing degree from operating situations of the steering angle sensor (11) and the accelerator position sensor (12); a method of detecting access to an intersection where the vehicle is going to turn right or left from a known car navigation system as one of the in-vehicle ECU group (19); a method of grasping access of an obstacle, another vehicle, or a pedestrian by processing a camera image of the periphery of the vehicle shot by the vehicle exterior imaging unit (17); and some other method.

When it is determined that the conversation ending condition has been satisfied in S123, the processing proceeds to S142, and the conversation started in S121 is ended. On the other hand, when it is determined that the conversation ending condition has not been satisfied in S123, the processing proceeds to S124.

In S124, the processing of recognizing utterance made by the user is performed, and the processing proceeds to S125. Recognition of the user's utterance is achieved by cooperation of the speech recognizer 61 that converts speech data to text data and the theme control block 81 that analyzes the generated text data. In S125, it is determined whether the topic having been used for a series of conversations can be completed.

A few examples will be cited as specific methods for determining whether the topic having been used for a series of conversations can be completed. In addition to the content information described above, the topic used in a series of conversations can be a topic based on a function provided in a variety of in-vehicle state detectors (10), such as a topic of setting a destination in the car navigation, a topic of asking how to use the function, and the like. In these cases, the topic can be completed in the following examples. In the case of the conversation based on the content information, a plurality of summary sentences are generated using a known sentence summarization technique, and those are sequentially outputted in accordance with the progress of the conversation to constitute the conversation. In this example, a state where all of summary sentences for one content have been outputted corresponds to the state where the topic can be completed. As an example of the case of the conversation of setting a destination in the car navigation, other than setting of the destination, a state where setting of the destination has been ended through the conversation at least once or more than once, including digression of asking for information relating to the destination, corresponds to the state where the topic can be completed. As an example of the topic of asking how to use the function, especially in the case of a complicated function, when all response descriptions are provided for one question, it is considered that the amount thereof is too large to be understood and grasped by the user. Hence it is appropriate to output the descriptions sequentially and output a description of the next step through dialog. In this example, the state where all of the plurality of descriptions for one function have been outputted corresponds to the state where the topic can be completed.

When it is determined that the topic cannot be completed in S125, the processing proceeds to S129. On the other hand, when it is determined that the topic can be completed in S125, the processing proceeds to S126. In S126, based on the processing of S124, it is determined whether there has been any utterance to allow grasping that the user has shown in interest.

In S126, for example, when it is determined that there has been no utterance of information and a question indicating that the user has an interest in information presentation for completing the conversation having been made a plurality of times on a series of themes, the processing proceeds to S127. In S127, based on the time measurement started in S122, it is determined whether a predetermined time has elapsed from the conversation start. When a positive determination is made that the elapsed time from the start of the conversation directed to the user has exceeded the threshold in S127, the processing proceeds to S128. In S128, it is determined whether the conversation on one topic has been repeated exceeding a predetermined number of times. In S128, when a positive determination is made that the conversation has been repeated a plurality of times based on one content information, and the number of repetition has exceeded the threshold, the processing proceeds to S129. In S129, based on each of the positive determinations of S127 and S128, it is determined that the conversation between the user and the dialog device 100 (cf. FIG. 1) has continued, and the processing proceeds to S135.

In S135, the activation status of the dialog execution block 71 is switched from the permitted state to the forbidden state, and the processing proceeds to S136. In S136, both the time measurement started in S122 and the number of repetition of the conversation counted in S134 described later are reset, and the processing proceeds to S 137. In S137, measurement of the elapsed time is started from the point of shifting to the standby state, and the processing proceeds to S138.

In S138, as in S123, it is determined whether the conversation ending condition has been satisfied. When it is determined that the conversation ending condition has been satisfied in 137, the processing proceeds to S142, and the conversation started in S121 is ended. On the other hand, when it is determined that the conversation ending condition has not been satisfied in S138, the processing proceeds to S139.

In S139, as in S124, the processing of recognizing utterance made by the user is performed, and the processing proceeds to S140. In S140, it is determined whether a condition for resuming the conversation has been satisfied. Examples of the conversation resumption condition include:

recognition of any utterance to allow grasping that the user has shown an interest in S139; and the lapse of a predetermined time after the shift to the standby state based on the elapsed time started to be measured in S137. Further, each of the following is also the conversation resumption condition: detection of input of a predetermined gesture; and cancellation input into the speech recognition operation switch 21 (cf. FIG. 1). When it is determined that the conversation resumption condition has not been satisfied in S140, the standby is kept until the conversation resumption condition is satisfied by repeating S138 to S140. When the conversation resumption condition is satisfied, the processing proceeds to S 141.

In S141, the standby state of the dialog execution block 71 is canceled and the processing proceeds to S142. By S141, the activation status of the dialog execution block 71 is returned from the standby state to the permitted state. In S142, a new conversation topic is set, and measurement of an elapsed time from the conversation start is started, and the processing proceeds to S132. When the user's utterance has satisfied the conversation resumption condition in S141 above, a topic is set in reflection of the content of the user's utterance in S142.

Meanwhile, when it is determined that there has been utterance of information and a question indicating the user's interest in S126 above, the processing proceeds to S130. In S130, it is determined whether the topic needs to be changed based on the content of the user's utterance. When it is determined that the topic needs to be changed in S130, the processing proceeds to S131. When it is determined that the topic does not need to be changed in S130, the processing skips S131 and proceeds to S132.

Also when a negative determination is made in S127 or S128 above, the processing proceeds to S131. In S131, the content information used for generating the conversational sentence is switched to perform the processing of changing the conversation topic, and the processing proceeds to S132. Additionally in S131, the number of repetition of the conversation counted in S134 described later is reset. According to S131, the information acquisition block 82 acquires new content information satisfying the condition set by the theme control block 81.

In S132, a conversational sentence to be provided to the user is generated and the processing proceeds to S 133. In S133, utterance of the conversational sentence generated in S132 is executed, and the processing proceeds to S 134. In S134, the counter that measures the number of repeated conversations on the current topic is increased just by one, and the processing returns to S123.

In the following, a description will be given of an example of the conversation between the user and the dialog device 100 achieved by the conversation execution processing described so far. In the following conversation, a news article relating to tennis is used as the content information. Although the name of an existing tennis player is uttered in an actual conversation, in the following description, direct indication of the name is avoided and <Tennis Player . . . > is mentioned.

Dialog device: “Do you know a news titled ‘<Tennis Player ND> wins victory with outstanding clutch’?”

User: “I didn't know.”

Dialog device: “It seems like <Tennis Player ND> won his fifth Australian Open title and his first in two year.

User: “Who was opponent in the final?”

Dialog device: “<Tennis Player AM> was.” All semi-finalists seem to be the big four players.

User: “I wonder how defeated <Tennis player AM> feels.”

At the end of the above first conversation chain, the user utters information which is ‘Tennis player AM.’ This utterance indicates that the user shows an interest in the conversation. Thus, for further continuing the current conversation topic, the theme control block 81 changes the content information to be used for generating the conversational sentence to content information including ‘Tennis Player AM’ (cf. S130 and S131 in FIG. 5). Based on the changed content information, a second conversation chain is developed as follows.

Dialog device: “Speaking of <Tennis Player AM>, <Tennis Player AM>, a runners-up, reportedly said “I shouldn't feel shame.”

User: “Although he lost, he still took a second place.”

Dialog device: “In the Australian Open, “<Tennis Player AM> lost to <Tennis Player RF> in the final of 2010 and lost to <Tennis Player ND> in the finals of 2011 and 2013. He said, “I want to get back here next year and expect a little different result in the final then.”, and then got a round of applause from the audience.”

User: “He has got to the final quite a lot, hasn't he?”

Dialog device: “Reportedly, <Tennis Player AM>, who had felt that he would also have a chance to win, looked back on the game, saying, “Apparently I also had a chance in the first three sets, but he won a clear victory in the fourth set. His returns from the base line are also marvelous.”

User: “I see.”

At the end of the above second conversation chain, the utterance is made indicating the faded interest. At this time, the conversation is in the state of completing the topic, the predetermined time has elapsed from the conversation start, and a plurality of times of conversations with the theme of ‘Tennis Player M’ have been performed (cf. S127 and S128 in FIG. 5). Hence, the utterance control block 73 shifts the dialog execution block 71 to the standby state based on the user's utterance without an interest (cf. S135 in FIG. 6).

Then, for example, with the user's talking to the dialog device as a trigger for resuming the conversation, the standby state of the dialog execution block 71 is canceled. Specifically, as a trigger for the user's utterance, a third conversation chain will be developed as follows:

User: “Well, which game <Tennis Player AM> will play next?” Dialog device: “Reportedly, he will take a rest for a while to get prepared for the US Open.”

User: “I see.”

At the end of the above third conversation chain, the utterance is made indicating the faded interest in the self-contained utterance presenting information, made by the dialog device 100. However, since the continuation of the conversation is insufficient, the state is not shifted to the standby state. Instead, the theme control block 81 performs a change in the topic with the aim of enhancing the user's interest (cf. S131 in FIG. 5). Specifically, the theme of the conversation is changed to ‘Tennis Player KN’ relating to ‘Tennis Player AM’.

As a result, a fourth conversation chain will be developed as follows:

Dialog device: “Speaking of the US Open, we are also looking forward to games of <Tennis Player KN>, aren't we?”

User: “yeah. I hope he will win the champion ship.”

Dialog device: “Reportedly, he has moved ahead of <Tennis player ND> and become a fourth-seeded player.”

(The conversation will be continued.)

In the present embodiment described so far, it is after the conversation between the user and the dialog device 100 continues that the state is shifted to the standby state in which the utterance to the user is suspended. Hence, a situation hardly occurs in which the conversation is terminated by the dialog device 100 without the user enjoying or being satisfied with the conversation with the dialog device 100.

Meanwhile, when the conversation between the user and the dialog device 100 continues, the dialog execution block 71 is set to the standby state unless there is utterance to allow grasping that the user has shown an interest (e.g., utterance of information from the user, utterance of a question, a gesture such as back-channeling and nodding, the tone of voice, etc.). Hence, a situation hardly occurs in which the conversation is continued while ignoring the user's wish to end the conversation, thereby making the user feel dissatisfied.

As above, according to the control of shifting the state to the standby state based on the user's reaction after continuation of a conversation to some extent, the dialog device 100 can provide the user with a natural conversation experience close to a conversation with a human. Accordingly, the dialog device 100 can achieve a conversation satisfactory to the user.

Further, in the present embodiment, the state is shifted to the standby state when there is no utterance to allow grasping that the user has shown an interest (e.g., utterance of information from the user, utterance of a question, a gesture such as back-channeling and nodding, the tone of voice, etc.) in information presentation with a content capable of completing the topic used in a series of conversations. In the initial stage and the middle stage of the conversation, where the topic cannot be completed by information presentation, the state is not shifted to the standby state. Hence a situation hardly occurs in which the conversation is one-sidedly terminated without completion of its content after only halfway information presentation.

Additionally in the present embodiment, in a case where the user does not make any utterance of information or a question in response to information presentation from the system side in a stage before the conversation continues to some extent, the conversation topic is changed by the theme control block 81 that estimates the state of the user having no interest. By such processing, the dialog device 100 can bring to an end the conversation on the topic that the user is not interested in, and attract the user's interest by a new topic. This can result in more enhancement in the user's satisfaction.

Further, in the present embodiment, the continuation of the conversation between the user and the dialog device 100 can be estimated with accuracy from combined determination of the elapsed time from the conversation start and the number of repetition of the conversation. By such combination of the criterions of determination as above, the continuation determination block 72 can precisely determine the continuation of the conversation with the user and shift the state to the standby state at appropriate timing. This can prevent the dialog device 100 from extending the conversation so as to make the user feel dissatisfied.

Further, in the present embodiment, when there is any utterance to allow grasping that the user has shown an interest, the standby state of the dialog execution block 71 is canceled. This enables the dialog device 100 to make a response in accordance with the user's utterance without delay even when being in the standby state. Moreover, the content of the user's utterance can be reflected to the content of the conversational sentence replied by the dialog device 100. This even more enhances the user's satisfaction to the conversation.

Furthermore, after the utterance control block 73 of the present embodiment shifts the dialog execution block 71 to the standby state, it cancels the standby state based on the lapse of time. According to the above, the dialog device 100 can repeatedly have a conversation with the user to such an extent as not to make the user feel dissatisfied, and exert the effect of holding the arousal so as not to bring the driver who is the user into the careless state.

In the present embodiment, the dialog execution block 71 and the conversational sentence generation block 83 correspond to the “conversation execution unit”, the continuation determination block 72 corresponds to the “continuation determination unit”, the utterance control block 73 corresponds to the “utterance control unit”, and the theme control block 81 corresponds to the “topic control unit.” Further, S127 to S129 in the conversation execution processing correspond to the “continuation determination step”, and S135 corresponds to the “utterance control step.”

### Other Embodiments

Although one embodiment has been illustrated above, the technical idea of the present disclosure can be realized as a variety of embodiments and a combination thereof.

In the above-described embodiment, the theme control block immediately changes the topic when the user comes to make no utterance to allow grasping that the user shows an interest, before continuation of the conversation with the user. However, even when the user's reaction is not favorable immediately after the conversation start, the user's reaction may turn to favorable in a short time. Therefore, even when the user's reaction is not favorable, the theme control block may be able to continue the conversation on the current topic without immediately changing the topic.

The continuation determination block in the above-described embodiment determines the continuation of the conversation from the start point of a series of conversation or the conversation resumption start point, with the elapsed time taken as the reference. However, the continuation determination block may be able to reset the timer for time measurement at the point of changing the topic, so as to determine the continuation of the conversation, with the continuation time for the conversation on one topic as a reference.

The continuation determination block in the above-described embodiment determines the continuation of the conversation, with the number of repetition of the conversation on one topic as the reference. However, the continuation determination block may determine the continuation of the conversation by taking as a reference the number of repetition from the time when a series of conversations is started or when the conversation is resumed.

The conversation starting condition (cf. S104 in FIG. 4) in the above-described embodiment can be changed as appropriate. For example, the dialog device can start a chat with the user, with the following as a trigger: inputting by the driver who has become aware of the careless state into a dialog start switch provided around the driver's seat; speaking of words such as “Let's have a chat” by the driver; utterance of a specific keyword by the passenger, or some other event. Similarly, the conversation resumption condition (cf. S140 in FIG. 6) can be changed as appropriate.

In the above-described embodiment, immediately before the dialog device 100 starts a series of conversations described below, the speaker 32 may output a notification sound that notifies the user of the conversation start. The notification sound can turn the user's awareness to the sound of the conversation. As a result, the user hardly misses a beginning part of the conversation started by the dialog device 100.

In the above-described embodiment, the detailed description has been given of the case where the dialog device is having a non-task-oriented conversation with the aim at intersection itself. However, the dialog device can have not only such a conversation as the chat described above, but also a task-oriented conversation, such as replying to a question asked by the passenger or making a reservation for a shop specified by the passenger.

In the above-described embodiment, each function in relation to execution of the conversation, provided by the processor 60a of the control circuit 60, may be realized by a dedicated integrated circuit, for example. Alternatively, a plurality of processors may be cooperated to execute each processing in relation to execution of the conversation. Each of the functions may be provided by hardware or software different from the above, or a combination of these. Similarly, the driving burden determination and the arousal determination provided by the processor 50a of the state information processing circuit 50 can also be provided by hardware or software different from the above, or a combination of these. Further, the storage medium for storing a program to be executed by each of the processors 50a, 60a is not restricted to the flash memory. A variety of non-transitive substantive storage medium can be employed as a configuration to store the program.

The technical idea of the present disclosure is applicable to communication equipment such as a smart phone and a tablet terminal and a dialog control program to be installed into a server outside the vehicle. For example, the dialog control program is stored in a storage medium of a communication terminal, which is brought into the vehicle, as an application executable by the processor. The communication terminal can dialogue with the driver in accordance with the dialog control program, and can hold the driver's arousal state through the dialog.

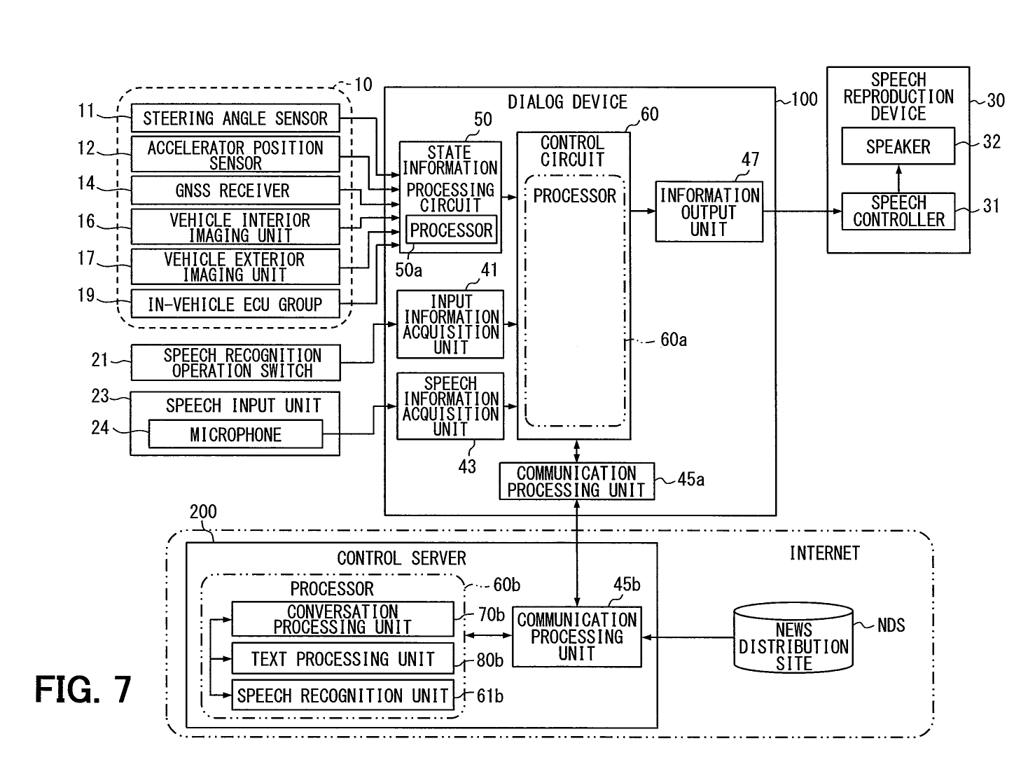

When the dialog control program is stored in the storage medium of the server, the server can acquire state information of the vehicle and the driver through the Internet. Further, the server can transmit conversational sentences, generated based on the acquired state information, to the speech reproduction device of the vehicle and reproduce the generated conversational sentences from the speaker. FIG. 7 is a block diagram showing an overall configuration of a dialog system according to the modified example. Since a basic configuration of the modified example is similar to that of the above embodiment, description of the common configuration is omitted by referring to the preceding description, and different points will be mainly described. Note that the same symbol as that in the above-described embodiment shows the same configuration.

In the above-described embodiment, by execution of a predetermined program by the processor 60a of the dialog device 100, the dialog device 100 constructs the speech recognizer 61, the conversation processing unit 70, and the text processing unit 80 as the functional blocks. In contrast, in the modified example, by execution of a predetermined program by a processor 60b of a control server 200, the control server 200 constructs a speech recognizer 61b, a conversation processing unit 70b, and a text processing unit 80b as functional blocks. That is, the speech recognizer 61b, the conversation processing unit 70b, and the text processing unit 80b provided in the remote control server 200 are configurations (clouds) that substitute for the functions of the speech recognizer 61, the conversation processing unit 70, and the text processing unit 80 of the dialog device 100 in the above-described embodiment. Accordingly, a communication processing unit 45b of the control server 200 acquires information required for processing of the speech recognizer 61b, the conversation processing unit 70b, and the text processing unit 80b via the communication network such as the Internet, and transmits the generated speech data for conversation directed to the user to the communication processing unit 45a of the dialog device 100, to reproduce the conversational sentence from the speech reproduction device 30. Specifically, while acquiring the content information from the news distribution site NDS and the like, the communication processing unit 45b of the control server 200 acquires from the dialog device 100 a variety of pieces of information such as the state information of the vehicle and the driver, having been inputted into the control unit 60 from the state information processing circuit 50, the input information acquisition unit 41, and the speech information acquisition unit 43 of the dialog device 100 in the above-described embodiment. The speech data for conversation directed to the user, generated based on the information as thus acquired, is transmitted from the communication processing unit 45b of the control server 200 to the communication processing unit 45a of the dialog device 100 via the communication network. In this case, a conversation speech of the user fetched by the dialog device 100 may go through conversion to a generally known digital-processed form, a form of an information amount compressed by a feature amount calculation, or some other form, and may be transmitted to the speech recognizer 60b in the control server 200 via the communication processing units 45a, 45b. Similarly, the speech data for conversation, created in the conversation processing unit 70b on the control server 200 side, and character data for image information display may also be transmitted to the dialog device 100 in the digitalized or compressed form, and outputted to the user. In FIG. 7, the configuration has been illustrated where the control server 200 is provided with the speech recognizer 61b, the text processing unit 80b, and the conversation processing unit 70b. However, the control server may be provided with some function of the speech recognizer, the text processing unit, and the conversation processing unit, and the dialog device may be provided with the other function. For example, the dialog device may be provided with the speech recognizer, and the control server may be provided with the text processing unit and the conversation processing unit.

As above, even when the dialog control program is installed in the server, a conversation between the driver as the user and the system can be achieved. Even the server-type dialog system can hold the driver's arousal state.

As above, the dialog control method performed by each of the communication equipment, the server, and the like which execute the dialog control program can be substantially the same as the dialog control method performed by the dialog device. The technical idea of the present disclosure is applicable not only to the dialog device mounted in the vehicle, but also to devices with the function of having a conversation with the user, such as an automated teller machine (ATM), a tool, a reception robot, and a care robot.

The technical idea of the present disclosure is also applicable to a dialog device mounted in a vehicle that performs automated driving (an autonomous traveling vehicle). For example, there is assumed automatic driving on an automated level where “a driving system automated in a specific driving mode performs an operation to drive a vehicle under a condition that the driver appropriately meets a driving operation switching request from the driving system.” In such an automatically driving vehicle, the driver (operator) needs to be held in a standby state for backup of the driving operation. It is thus presumed that the driver in the standby state tends to enter the careless state or the drowsy state. Accordingly, the dialog device as thus described is preferable also for the configuration to hold the arousal of the driver who is in the standby state as the backup of the automatic driving system.

What is claimed is:

1. A dialog device comprising:
a conversation execution unit that executes a conversation with a user;
a continuation determination unit that determines whether the conversation executed by the conversation execution unit and directed to the user continues; and
an utterance control unit that controls the conversation execution unit to be in a standby state in which utterance to the user is suspended when the continuation determination unit determines that the conversation continues and no utterance shows that the user expresses an interest in an information presentation provided by the conversation execution unit.

2. The dialog device according to claim 1, wherein:
the utterance control unit controls the conversation execution unit to be in the standby state when no utterance shows that the user expresses an interest in an information presentation having a content for completing a topic used in a series of conversations.

3. The dialog device according to claim 1, further comprising:
a topic control unit that changes the topic of the conversation directed to the user when the continuation determination unit determines that the conversation does not continue and no utterance shows that the user expresses the interest in the information presentation provided by the conversation execution unit.

4. The dialog device according to claim 1, wherein:
when an elapsed time from a start of the conversation directed to the user by the conversation execution unit exceeds a threshold, the continuation determination unit determines that the conversation between the user and the conversation execution unit continues.

5. The dialog device according to claim 1, wherein:
when the conversation between the conversation execution unit and the user is repeated a plurality of times, the continuation determination unit determines that the conversation between the user and the conversation execution unit continues.

6. The dialog device according to claim 1, wherein:
when the conversation execution unit is in the standby state, the utterance control unit cancels the standby state of the conversation execution unit based on a feature that the utterance shows that the user expresses the interest.

7. The dialog device according to claim 1, wherein:
after the utterance control unit shifts the conversation execution unit to be in the standby state, the utterance control unit cancels the standby state of the conversation execution unit, based on a feature that a predetermined time has elapsed.

8. A dialog control method for controlling a conversation execution unit that executes a conversation with a user, the dialog control method comprising: as steps to be executed by at least one processor,
a continuation determination step of determining whether a conversation executed by the conversation execution unit and directed to the user continues; and
an utterance control step of controlling the conversation execution unit to be in a standby state in which utterance to the user is suspended when it is determined that the conversation continues in the continuation determination step and no utterance shows that the user expresses an interest in information presentation provided by the conversation execution unit.

9. The dialog control method according to claim 8, wherein:
the continuation determination step and the utterance control step are performed by a processor in a remote server connectable with a speech reproduction device, which reproduces speech data for conversation directed to the user, via a communication network.

10. (canceled)

11. A dialog system comprising:
a remote server having a processor that executes the continuation determination step and the utterance control step according to claim 8; and
a dialog device including
a communication processing unit that receives the speech data for conversation directed to the user via the communication network, the speech data generated by the remote server, and
an information output unit that outputs the speech data, for conversation directed to the user, to a speech reproduction device, the speech data received by the communication processing unit.

12. A non-transitory tangible computer readable medium comprising instructions being executed by a computer, the instructions including a computer-implemented method for executing the continuation determination step and the utterance control step according to claim 8 in the at least one processor.

13. The non-transitory tangible computer readable medium according to claim 12, wherein:
the computer-implemented method is an application executable in a communication terminal.
